(19) United States
(12) Patent Application Publication
(10) Pub. No.: US 2008/0027810 A1
(43) Pub. Date: Jan. 31, 2008

(54) Coupons and systems for generating coupons on demand

(76) Inventors: Jeffrey M. Lerner, Houston, TX (US); Matt Whitney, Houston, TX (US); Michael McCarthy, Chicago, IL (US); Timothy Harris, Chicago, IL (US)

Correspondence Address: KEITH B. WILLHELM, ATTORNEY AT LAW, 6266 DEL MONTE, HOUSTON, TX, 77057, US

(21) Appl. No.: 11/821,115

(22) Filed: Jun. 21, 2007

(51) Int. Cl. G06Q 30/00

(52) U.S. Cl. 705/14

(57) ABSTRACT

Coupons which are displayed as a text message on a mobile telecommunication device and include a code uniquely identifying the coupon are provided for. Systems for generating coupons on demand are also provided for. The system comprises an agency computer having access to a coupon database. The coupon database comprises information on offers and a location value assigned to each offer. The agency computer is connectable to a mobile communications network or other network for transmitting electronic mail. It receives requests for coupons from consumers that are transmitted via the network. Preferably, the requests originate from cells phones or other mobile telecommunication devices and are transmitted to the agency computer via a mobile communications network. The request is a text message that includes information identifying the consumer's location. The agency computer system identifies a coupon in the coupon database that is responsive to the coupon request based on the consumer's location and the offer location value. It then sends the identified coupon to the consumer via the network.

The present invention relates to advertising coupons used to promote goods and services, and more particularly, to improved coupons and to improved systems and methods for distributing coupons on demand in response to consumer requests.

### BACKGROUND OF THE INVENTION

Many products and services, and especially those directed toward consumers, are promoted extensively using coupons. Merchants issue coupons that entitle consumers to a discount or other incentive designed to encourage consumers to patronize the merchant. They are designed primarily to increase sales of the merchant and, therefore, merchant coupons are issued by a merchant and the cost of any discount or incentive is absorbed by the merchant. Manufacturers and franchisors also issue coupons for discounts on their products with the hope of expanding the market for those products. Consumers may redeem the coupons with merchants selling the product. The merchants in turn are reimbursed by the manufacturer or franchiser who issued the coupon.

Printed coupons are by far the most common coupon in use today. Approximately 340 billion coupons are printed each year in the United States alone, and advertisers have relied on many different ways to deliver those coupons. Currently, the favored method is distributing printed coupons through mass media, such as magazines or newspapers, or through direct mailing, either as an insert or dimensional mail piece. Coupons inserted in newspapers constitute the vast majority of the coupons distributed primarily because of their extremely low cost—approximately $0.007 per coupon.

A substantial portion, if not the substantial majority of all coupons distributed are never viewed by their intended audience for one reason or another. Many consumers receiving a coupon may have no interest in the advertised goods, or they may not be able to afford them. There also is a general clutter of advertisements that makes it difficult for a particular coupon to capture the attention of consumers, especially if a consumer is distracted or otherwise occupied when an opportunity for viewing the coupon arises. Thus, most coupons are not viewed and never redeemed. The average redemption rates for coupons distributed as newspaper inserts, by far the most common distribution method, are only about 1 percent.

Most coupon distribution methods, therefore, are very inefficient and wasteful. Moreover, because of that inefficiency, the effective cost for each advertising message that stimulates a desired consumer response is generally many times higher than the nominal cost per message. Despite, and in part because of the number and variety of conventional methods, advertisers continue to seek more cost effective ways of disseminating advertising messages. In particular, there is a continuing need for more effective and more economical methods for distributing coupons.

More recently, coupons have been delivered electronically via the Internet and telecommunication systems. Various services “broadcast” e-mails that include coupons, or links to websites where coupons may be accessed to a list of e-mail addresses. There also are services that broadcast coupons as text messages to a database of telephone numbers. The cost of cost of delivering coupons via broadcast systems may be relatively low, but the cost of collecting or otherwise obtaining lists of e-mail addresses or telephone numbers is quite high. Such services also do not offer consumers the ability to request coupons on demand. In fact, the vast majority of consumers receiving such broadcasts may have no interest in the products or no desire to receive promotional e-mails or text messages. The response rate for broadcast coupons, therefore, is usually very low.

Services have attempted to broadcast electronic advertising to a more targeted audience by providing “opt-in” services. That is, advertising is broadcast only to consumers who have elected to receive advertising. In theory this might suggest higher response rates, but in practice that is not necessarily so. Opt-in coupons typically are delivered according to a schedule predetermined by the service provider. Thus, the coupon may not be delivered at a time when a consumer is most receptive to the offer.

Some “opt-in” services allow a consumer to select predetermined criteria that will determine the types of coupons he will receive. The ability to select criteria, however, also may not significantly increase the likelihood that a consumer will receive a coupon in which he has an immediate interest. For example, a consumer may have opted-in to a service when he was thinking about taken a vacation. Unless the consumer has taken time to update his criteria, he will still receive offers on transportation, lodging and other travel related services long after he takes his vacation and his interest in such offers has waned.

In addition, spam detection software is widely used, especially as applied to e-mail networks. Such software may block the delivery of or delete broadcast messages, or it may move them to junk mail folders where they are unlikely to be viewed. As with printed advertising, there also is a general clutter of e-mails and a growing clutter of text messages. That clutter may make it difficult for a particular coupon to capture the attention of consumers, even if it delivered via an “opt-in” service. From 85% to 99% of e-mailings are never opened.

Accordingly, various systems have been devised to deliver electronic coupons on demand. Those systems offer the promise of delivering coupons to consumers when they are ready to make a purchase and, therefore, the promise of higher redemption rates. Those promises, however, remain largely unfulfilled. Such systems are most commonly web-based, meaning a consumer is required to access a website to obtain coupons. Typically, as with most “electronic” coupons, they are printed from a website by the consumer.

For example, manufacturers may allow consumers to print coupons from their websites. There also are various websites that compile coupon offers from different sources or search the web for coupon offers. Such services place a high value on information about their users, and therefore, they require their users to register with the service. The registration process usually requires consumers to provide names, addresses, e-mail addresses, and demographic information. Many consumers recognize that such information is not really required as a technical matter to give them access to a coupon. They may be afraid that their personal information will be misused or may simply resent having to provide their personal information. Thus, they may decline to register for such services.

Even if a consumer is willing to register with a service, he typically must navigate various additional screens and make additional choices to identify prospective coupons or to obtain access to a coupon. The consumer also may be directed to other websites—which also may require registration—before he obtains access to a coupon. After all that, he may have to install special software in order to print the coupon. It is no wonder then, that many consumers are frustrated with the complexity of such systems and resent the many hurdles they must overcome in order to access coupons.

This is particularly true for consumers who are not at home and are faced with an immediate need or desire to make a purchase. First of all, such consumers may not have Internet access. Mobile access to the Internet has been made much easier by devices such as laptop computers, personal digital assistants (PDA's), and even cell phones, but they still present significant impediments to the use of web-based coupon distribution systems. Laptops are cumbersome and require Internet connectivity via a wireless network or other connection, but typically offer larger displays that are more suitable for accessing web-based systems. PDA's and cell phones are more easily transported and can access the Internet via a wireless telecommunications network, but their screens are poorly suited to navigate web-based coupon systems. If a coupon must be printed to be redeemed, that presents a typically insurmountable obstacle to mobile consumers. Thus, while such services may be able to provide consumers with coupons in response to particular requests, they still may not be able to deliver coupons to consumers sufficiently close to a purchasing decision in order to maximize their efficacy.

The MSGME^{SM} service provides a system for delivering content to cell phones and other mobile telecommunication devices as text messages. A merchant can establish its brand name or other indicia as a keyword with the service. When consumers text message the merchant's keyword to the service's short code, the service delivers a text message to the consumer's cell phone. The text message is determined by the merchant and may constitute a coupon. The success of such systems, however, depends on how effectively a merchant is able to educate consumers. A merchant must conduct advertising sufficient to educate consumers about the merchant's keyword and what to expect in response to sending the keyword. Accordingly, this system has modest success as a coupon delivery service.

The Cellfire^{SM} system is a service for delivery of coupons to cell phones and other telecommunication devices. Like conventional web-based systems, it requires consumers to register with the service. It also requires them to download special application software to their cell phone and to subscribe to data transmission services. After a consumer has registered and set up the service, he is able to download an assortment of coupons from the service by executing an appropriate command. Since numerous coupons are downloaded, they are stored and not immediately displayed on the consumer's cell phone. A consumer must execute a number of commands to view and select coupons of interest.

Many systems, while adequate for distributing manufacturer coupons on a wide scale, also are not well suited for distributing coupons on behalf of smaller, localized merchants. They may be too expensive or ineffective for such merchants, especially to the extent that they distribute coupons to consumers who do not have a realistic opportunity to act upon the coupon.

Another problem associated with coupons, again from the perspective of merchants, is that they offer an opportunity for fraud. That is, employees of merchants accepting coupons may claim to have received a coupon from a consumer when in fact a consumer did not present a coupon. An employee then may be able to pocket the value of a coupon from the amount paid by a consumer. Such problems are diminished for paper coupons. They create a paper trail, and dishonest employees must devote significant time and effort to collecting legitimate coupons or printing counterfeits. Fraud also is more difficult when consumers pay by credit or debit cards. For those merchants who handle a lot of cash transactions and honor electronic coupons, however, fraud is real possibility. An employee may falsely claim to have been presented with electronic coupons and could easily pocket the value of “phantom” coupons.

An object of this invention, therefore, is to provide improved systems and methods for directly disseminating coupons to consumers and, more specifically, to provide improved systems and methods for disseminating coupons electronically on demand. It also is an object to provide such systems and methods that are more easily accessed by consumers. Another object of this invention is to provide systems and methods that are able to deliver coupons more cost effectively, especially on behalf of smaller, more localized merchants. It is a further object to provide electronic coupons, and systems and methods for their dissemination, which are less susceptible to fraud and abuse. Yet another object is to provide such methods, systems, and coupons wherein all of the above-mentioned advantages are realized.

Those and other objects and advantages of the invention will be apparent to those skilled in the art upon reading the following detailed description and upon reference to the drawings.

### SUMMARY OF THE INVENTION

The subject invention provides for coupons that are stored or displayed on a mobile telecommunication device and include a code uniquely identifying the coupon. Preferably, the text message and unique coupon code are displayed as a text message, more preferably as a short message system text message. The subject invention also provides for coupons that are stored or displayed on a mobile telecommunication device and have a digital signature. It will be appreciated that such novel coupons significantly reduce the opportunity for fraud associated with redemption of coupons.

The subject invention also provides for systems and methods of generating coupons on demand, that is, upon request by a consumer. The system comprises an agency computer having access to a coupon database. The coupon database comprises information defining one or more offers and a location value assigned to each offer. The agency computer is connectable to a network for transmitting electronic mail, preferably to mobile telecommunication devices via a mobile communications network. It receives requests for coupons from consumers that are transmitted via the network for transmitting electronic mail. Preferably, the requests originate from mobile telecommunication devices, such as a cell phone, and are transmitted to the agency computer via a mobile communications network. The request is a text message that includes information identifying the consumer's location. The agency computer system identifies a coupon in the coupon database that is responsive to the consumer's coupon request based on the consumer's location and the offer location value. It then sends the identified coupon to the consumer via the network for transmitting electronic mail, preferably to the consumer's mobile communication device via the mobile communications network.

A consumer request also preferably includes information identifying a desired merchant or product. It will be appreciated that by utilizing a mobile communications network or other electronic mail networks and requests that include a consumer's location and, preferably, desired merchant or product information, the system offers significant advantages. Especially when mobile communication devices and networks are utilized, the novel systems are able to deliver on demand coupons to consumers at a point when they are not only ready to make a purchase, but are more likely to be able to make a purchase from a merchant sponsoring the coupon. Thus, it is believed the systems will generate coupons that have significantly higher redemption rates and more effectively promote a merchant's goods and services. A consumer also is not required to register with services utilizing the novel systems and may obtain coupons simply by sending a text message. Thus, it is expected that the novel systems will be more accessible to consumers.

The agency computer system also preferably maintains a record of coupons requested by a consumer and a record of coupons distributed for each merchant. The system thereby is able to generate billing data for a merchant based on the number of coupons distributed. The agency computer system is also able analyze the record of coupons requested by a consumer to identify products or merchants of interest to the consumer and send the consumer additional coupons based on that interest.

### BRIEF DESCRIPTION OF THE DRAWINGS

FIG. 1 is a schematic diagram showing a preferred embodiment of the systems of the subject invention and a broader network in which it may be used to distribute coupons.

FIG. 2 is a schematic diagram of a preferred embodiment of the methods of the subject invention showing a sequence of steps for generating and distributing coupons.

### DESCRIPTION OF ILLUSTRATIVE EMBODIMENTS

The systems and methods of the subject invention are designed to receive consumer requests for coupons and to identify and distribute coupons of interest almost immediately over a mobile communications network and other networks for transmitting electronic mail. The coupons advertise offers relating to identified products or services, and consumers are able to present the coupons to merchants honoring the coupons to obtain the benefit of the offers.

The novel systems and methods most commonly will be practiced by an advertising agency. The agency will contract with merchants to distribute coupons to consumers on behalf of the merchant. The agency will promote the coupon service to consumers and encourage them to request coupons through their cell phones, other mobile communication devices, or other devices capable of sending and receiving e-mail. It will be understood, however, that while the invention will be described primarily with this model in mind, it is not necessary for the system to be operated by an advertising agency. It also may be run directly or indirectly by merchants or others.

It is believed that the novel systems and methods are particularly effective in distributing coupons on behalf of retail merchants and ultimately in increasing retail merchant sales. Thus, the discussion of preferred embodiments herein will focus on what are commonly referred to as “merchant” coupons, i.e., coupons issued by merchants. The invention, however, also may be used to distribute “manufacturer” coupons, i.e., coupons that are issued by a manufacturer or a franchisor who reimburse merchants honoring the coupon. References to merchants, therefore, may also be understood in a broader sense as including any person who issues a coupon through the novel systems and methods.

The discussion in large part also is confined to “products” and especially to consumer products distributed at the retail level. The invention, however, is not so limited. It may be used to advantage at wholesale or other distribution levels. “Products” also should be understood as including what otherwise may be more aptly described as services.

### Establishing a Coupon Database

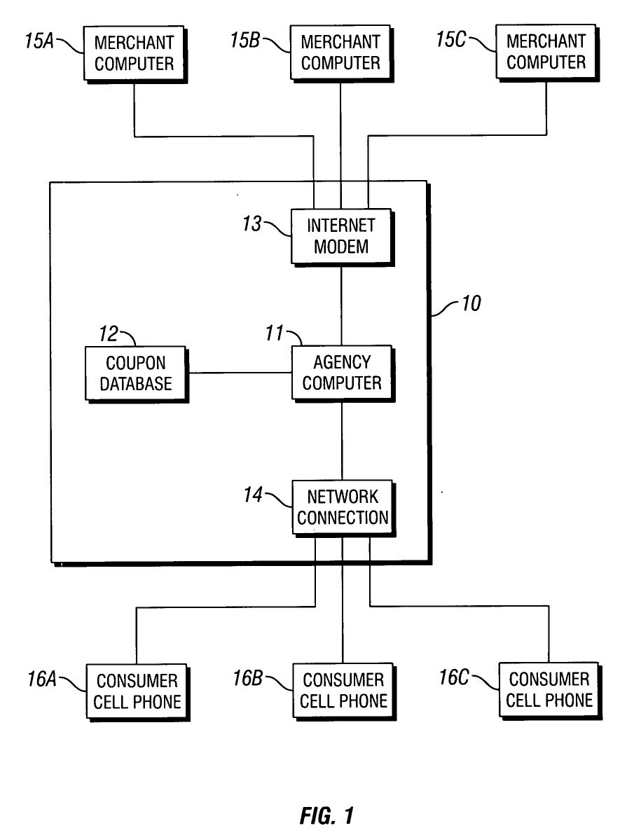

The novel systems include an agency computer having access to a coupon database. For example, as shown in FIG. 1, a preferred embodiment 10 of the novel system includes agency computer 11 which has access to database 12. The system 10 generally will be operated by an advertising agency. Since the system may be run directly or indirectly by merchants or others, the reference to an “agency” computer, computer system, or database is for convenience only.

The coupon database utilized by the novel systems and methods comprises information defining one or more offers for products and a location value assigned to each of the offers. Additional information, however, may be stored in the coupon database or may otherwise be accessible by the agency computer as may be necessary or desirable for billing, tracking, or other purposes.

The offer information will vary and may include any information deemed pertinent by a merchant. It preferably includes at a minimum such terms as are legally sufficient to define the offer that a coupon represents. Accordingly, offer information may, and usually will include such information as a product description and the price or discount to be applied. If an offer will be honored only by certain merchants or locations, that information also will be included. Offer information also may include expiration dates, limits, and other terms and conditions imposed by a merchant. It may include offer codes to assist in tracking the effectiveness of campaign, and usually will include such codes if a manufacturer, franchisor, or other third party will reimburse a merchant who honors the coupon.

Information for each offer may be entered into the coupon database by the agency or by a merchant. More commonly, however, an agency may prefer to handle registration of new merchant clients and entry of various basic setup information pertaining to the merchant into a database. The database then may used by default to define offers or for billing or other purposes. Once a client is registered, it would have at least partial access to those portions of the database that pertain to it. Clients preferably will be able to enter directly any additional offer information which they are required or desire to specify. Of course, the agency or a merchant may choose to specify some offer information by default.

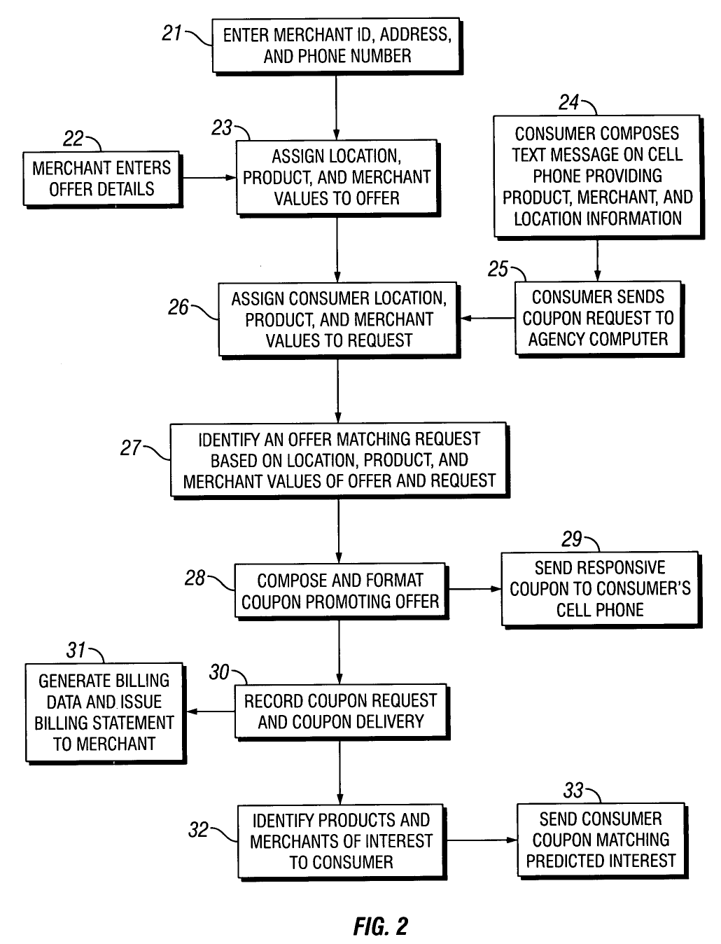

For example, as shown in step 21 of FIG. 2, an agency enters information identifying a merchant, such as the merchant's name or a code assigned by the agency, into the database 12 via agency computer 11. If the merchant has multiple retail location, identification information for each location preferably is entered. Such information may be required for billing or reporting purposes. It also may be used to define offers and, as discussed further below, to assign merchant values to offers that will enable the system to more effectively identify coupons of interest to consumers.

Merchant addresses and phone numbers also may be entered into the system 10 as shown in step 21. Such information obviously is useful for billing and reporting purposes. Preferably, however, a merchant's address and phone number will be included in coupons to assist consumers in redeeming the coupons. The address preferably is a street address, but less detailed or specific location information also may be entered if consumers are able to rely on that information to locate a merchant. As discussed in detail below, the address information also may be used to define location values that will be used by the system to identify coupons of interest to a consumer.

An agency may choose to enter some or all of any additional information that will be used to define the offers. Especially with established clients, however, the agency generally will allow additional offer information to be entered into the coupon database by a merchant. For example, as reflected in FIG. 1, merchants preferably are able to access the agency computer system 10 from a merchant computer 15 via a modem 13. The agency computer system 10, in that event, preferably provides a web-based client interface. The agency may allow clients to register with the service on the interface webpage. Clients generally will be able to use an interface webpage to enter and update information pertaining to their account and their promotions. Other connections and systems for allowing merchants to directly input data into the agency database 12, however, are known or may be devised and may be implemented with the novel systems.

Thus, as shown in step 22 of FIG. 2, a merchant may enter offer details into the agency database 12. Typically, details such as a product description and the price or discount to be applied will be specified by the merchant. If an offer will be honored only by certain locations, or if not specified by default, that information also will be included. The offer information also may include offer codes, expiration dates, limits, and other terms and conditions. That may be accomplished by accessing a client webpage maintained by the agency and entering offer details via menu choices or text boxes. Alternately, offer details may be uploaded into the agency database 12 via the client webpage or other link. Such details may be defined as applying to particular offers or a default values. An agency generally will prefer to compose and format coupons in their final form, or at least limit a merchant to predefined formatting options, but fully or partially composed coupons may be entered or uploaded into the database 12. As noted, some offer details, such as expiration date, may be defined by default.

In accordance with the subject invention, the coupon database accessible to the agency computer system also includes information defining a location value assigned to each offer. The location value will be used to determine whether a coupon promoting the offer will be sent in response to a particular request. Thus, the location value assigned to an offer may used to define, or it may represent an area where coupons promoting an offer may be distributed. The distribution area usually will be the area from which a merchant expects to attract consumers with its coupon, or it may the area in which a merchant is willing to make deliveries. Such areas may be defined in any number of ways as desired or convenient. For example, a distribution area may be a defined distance from a location value such as a merchant address. It may be a zip code or a set of zip codes. Alternately, formal or informal geographic regions or political divisions may be used to define distribution areas. They also may be defined by reference to institutions, such as college and university campuses. Landmarks or any other reference point having a geographical connotation, especially those which are recognized as such by consumers, may be used. Examples of such in the Houston, Tex. area might include “The Heights,” “Montrose,” the “Galleria” area, the “Villages,” the “Memorial” area,” and “Westchase.”

Thus, for example, in step 23 a location value is assigned to each offer. The address where coupons promoting the offer may be redeemed may be assigned as the location value for the offer. Such information typically will be entered in any event. It then may be used, for example, with mileage calculators if a coupon will be distributed within a specified distance from the merchant. Alternately, a location value may be assigned automatically to an offer by the agency computer 11 based on the redemption address or another address provided by the merchant in accordance with predefined rules. The zip code also generally will be entered into the agency database 12 and may be used as the location value. The street address or zip code also may be used to assign location values corresponding to a set of zip codes, a geographic region, political division, or areas surrounding a recognized institution or landmark.

Location values also may be assigned manually by the agency, or they may be selected by the merchant, for example, by menu choices or text boxes available to the merchant on the agency's client interface webpage. An offer may be assigned more than one location value if, for example, it will be honored at more than one merchant location or the coupon will be distributed in more than one defined area. Such situations also may be treated by the system as distinct offers.

In addition, location values preferably are correlated to “keywords” that will be used, as discussed in further detail below, by consumers to compose coupon requests. Such keywords shall be understood to be a set of text characters, including a single character that has been defined as a “hot key,” that are included in a coupon request and that are defined in the system by an agency, merchant, or consumer and recognized by the system as having a particular value, such as a location value. Preferably, location value keywords are names, abbreviations, zip codes, or other alphanumeric designations that are recognized by consumers as geographic designators. Examples of such location value keywords in the Houston area might include UHMC (University of Houston Main Campus), RICE (Rice University), MEDC (Medical Center), HEIGHTS, MONTROSE, GALLERIA, VILLAGES, and WESTCHASE.

Location value keywords may be used to designate location values at a source code level, or they may actually be employed by a merchant to assign a location value to an offer. For example, a merchant may be able to assign a location value to an offer by typing zip codes into an appropriate text box on the client interface webpage. More typically, however, location value options will be presented to the merchant in the form of menu choices offered to a merchant based on the merchant's zip code, address or other criteria.

Preferably, a merchant value and a product value also are assigned to each offer, for example, as shown in step 23 of FIG. 2. Such values may allow for more effective matching of consumer requests to specific coupons. As with a location value, the merchant and product values may be assigned manually by the agency. They also may be assigned by a merchant in inputting its information via, for example, suitable menu choices or text boxes on the agency's client interface webpage. They also may be assigned automatically by the agency computer 11. For example, the merchant name or client code may be assigned automatically to all offers by the merchant.

In any event, however, merchant and product values also are preferably correlated to one or more names or abbreviations for the merchant and the product or product categories that are established by the merchant or agency as keywords. The keywords preferably will be recognizable by the consumer as such. For example, typical product and product category keywords for restaurant clients may be PIZZA, BURGERS, SALADS, TEXMEX, CHINESE, BREAKFAST, LUNCH, TAKEOUT, FAST. As discussed in detail below, such keywords then may be used by consumers to compose coupon requests.

As a more specific example of how the novel systems and methods may be implemented, a merchant, Papa's Pizza Pie Palace solicits the WHAMtext advertising agency to distribute coupons on its behalf. WHAMtext registers Papa's by entering its name, street address, including zip code, and phone number into its computer system. After the initial set-up, Papa's is able to access WHAMtext's website to enter details on coupons it would like to issue. It enters the text for two coupons in text boxes provided for that purpose: “Two large Meat-Eater pizzas for $20” and “24 Wicked Wings for $10.” Papa's also selects PIZZA as a keyword product value for the first coupon, WINGS as a keyword product value for the second coupon, and TAKEOUT as a keyword product category for both coupons. It defines “PAPA” as a keyword merchant value for the coupons. WHAMtext's computer system will recognize common variations of “PAPA,” such as “Papa's” and “Papas”. Finally, Papa's selects RICE as a location value keyword to define an area in which it wishes to distribute both coupons. The system automatically assigns a set of zip codes corresponding to the RICE area as keyword location values for the coupons.

This process will be completed for a number of merchants and a variety of coupon offers until the agency computer system has a database of promotional coupons available for distribution to consumers. The agency then will promote the service to consumers and educate them on how to use the service to request and receive coupons on demand by using their cell phone, other mobile communication device, or other device capable of sending and receiving electronic mail. Merchants also may promote the service and the ability to obtain their coupons through the service.

### Receiving Coupon Requests

The agency computer of the novel systems is connectable to a network for transmitting electronic mail, and preferably, to mobile telecommunication devices via a mobile communications network. It is operable to receive requests for coupons from consumers via the electronic mail network, and preferably requests that originate from a mobile telecommunication device and are transmitted to the agency computer via a mobile communications network. For example, as shown in FIG. 1, agency computer 11 is connectable to cell phones 16 via a network connection 14 compatible with a mobile communication network.

It should be noted that in describing this and other preferred embodiments, reference most frequently will be made to a consumer's cell phone. This is by far the most common mobile communication device in use today. The novel systems and methods, however, may be applied to distribute coupons to any mobile communication device that is capable of transmitting text messages over a mobile communications network. Many personal digital assistant (“PDA”) devices, for example, have such capabilities and may be used to transmit requests to the novel systems. They also may be used to receive requests from and distribute coupons to any device capable of sending and receiving electronic mail, such a conventional desktop and laptop computers.

The consumer requests utilized by the novel systems and methods are electronic mail, preferably text messages that include information identifying the consumer's location. Preferably, however, additional information is provided by the consumer in his coupon request and inputted into the agency computer. For example, as shown in step 24 of FIG. 2, a consumer may use his cell phone 16 to compose a text message requesting a coupon. The text message includes text characters identifying a desired product and merchant. A product and merchant may be identified by any name, or abbreviation thereof, in common usage by consumers. For example, a product may be identified by its generic or brand name, and a merchant may be identified by its trade name.

Preferably, however, desired products and merchants are identified by a set of text characters, including a hot key, that are recognized by the system as a keyword having a defined product or merchant value. Such keywords are correlated by defined rules to the product and merchant values that are assigned to offers. Preferably, keywords are defined based on common usage by consumers, and thus, they may used by consumers without any awareness that they are “keywords.” Alternately, keywords may not be in common usage, but may be recognizable variations or abbreviations thereof. Thus, an agency or a merchant may be able to easily educate consumers about their use. More arbitrary keywords may be employed, but they may require more consumer education. The system also may allow a consumer to establish personal keywords, for example, by registering with the service and accessing a consumer interface webpage maintained by the agency. As discussed in further detail below, the inclusion of product and merchant information will allow for more effective matching of consumer requests to specific coupons.

In accordance with the subject invention, the coupon request includes information identifying a consumer's location. For example, as shown in step 24 of FIG. 2, a consumer includes in his text message text characters that identify his location. The identified location will be the location where a consumer expects to make a purchase. Typically that will be the consumer's current location because consumers using the service generally will be interested in receiving a coupon for immediate redemption proximate to their current location. If a consumer expects to make a purchase in an area other than where he is currently located, however, he will enter information identifying that distant location.

The location information may be a street address, but generally it will be less specific as a consumer may not know the exact address where he is then located. Accordingly, the location information typically will only identify a consumer's location generally. For example, it may be the zip code where a consumer is located or to which he will be traveling. Alternately, it may be a formal or informal geographic region or political division, an institution name, a landmark, or any other reference point recognized by a consumer as generally defining his location.

Preferably, however, as with product and merchant information, a consumer's location will be identified by keywords that are recognized by the system as a keyword having a defined location value. Such keywords are correlated by defined rules to the location values that are assigned to offers. Preferably, location keywords are based on common usage by consumers or recognizable variations or abbreviations of terms in common use. The system also may allow a consumer to establish personal location keywords. As discussed in further detail below, the location information will be used by the system to identify offers responsive to consumer coupon requests.

Many mobile communication devices are capable of automatically registering their location, for example, through global positioning systems (GPS). Some devices are capable of storing location information in the form of cookies or otherwise. Accordingly, a coupon request may include information derived from GPS and other such systems or stored in the device, either reduced to text characters in the text message itself, as hidden text or embedded code, or as an attachment to the text message. Any automatically registered data, however, will necessarily register a consumer's current location, even if it does not coincide with the area in which he will be shopping. Likewise, stored data may or may not be the area where the consumer is presently located or in which the consumer will be shopping at a particular point in time. Thus, manually entering the location as text characters, or converting automatically generated location information to text characters that can be edited; may be preferred. A consumer then would be able to identify a location other than his current location or the stored information, where he expects to redeem a coupon.

In accordance with a preferred aspect of the novel systems and methods, the coupon request is a Short Message Service text message. Short Message Service (SMS) is a telecommunications protocol that allows the sending of “short” text messages, i.e., text messages that are 160 characters or less. SMS arose as part of the Global System for Mobile Communications (GSM) and is now widely available on most digital mobile telecommunication devices, such a cell phones and personal digital assistants with onboard wireless telecommunications. SMS, for example, is available on all major U.S. wireless telecommunications providers such as Verizon, Sprint, T-Mobile, and ATT. Thus, the novel systems and services will be established to utilize SMS text messages in order to have the widest possible reach.

There are other protocols by which mobile telecommunication devices are able to transmit text messages over mobile telecommunications networks, however, and such protocols may be used to the exclusion or in addition to SMS text messaging. For example, NTT DoCoMo's ShortMail service and Softbank Mobile's SkyMail service in Japan provide text messaging using other protocols, and RIM's BlackBerry service in he United States uses standard mail protocols such as SMTP over TCP/IP which are used in less mobile electronic mail devices.

It will be appreciated, however, that SMS text messages also have the advantage of near instantaneous delivery, especially when transmitted directly from one telecommunication device to another. This enables the system to be responsive to immediate needs of consumers. Other types of electronic mail systems, such as those relying on standard mail protocols transmitted through the Internet, may not be delivered as quickly. Thus, and also because of their availability on mobile communication devices and networks in which the invention has particular advantage, text messages and especially SMS text messages are a preferred protocol for receiving coupon requests.

### Identifying and Distributing Responsive Coupons

The agency computer of the subject invention is operable to receive the coupon request and, in response thereto, to identify an offer in the database that is responsive to the consumer coupon request based on the consumer location identified in the request and the location value assigned to the offer. The agency computer preferably identifies responsive coupons based also on product and merchant information contained in the request and the product and merchant values assigned to offers. For example, after a consumer has composed a coupon request on his cell phone 16, he sends it to the agency computer 11 via the mobile communications network and network connection 14, as shown in FIG. 1 and in step 25 of FIG. 2. The agency computer 11 then, as shown in step 26, analyzes the request and assigns a location value, product value, and merchant value to the request. That information then is used to identify coupons matching the request, as shown is step 27.

The agency computer 11 analyzes the text message for recognizable character strings. Preferably, the agency or the merchants have either defined the keywords based on common usage or have conducted appropriate consumer education so that the coupon request is composed from established keywords. The agency computer 11 will immediately recognize them as such and assign the keywords the appropriate values. If a request is composed using native language, the agency computer preferably will analyze the request for recognizable native language character strings, and then assign the appropriate location, product, and merchant values to the request based on predetermined rules. Once the request is assigned a consumer location, product, and merchant value, that information is correlated in accordance with predetermined rules to an offer in the coupon database based on the location, product, and merchant values assigned to the offer.

The system may be understood at its simplest level by assuming that a system's coupon database has a variety of offers, each having assigned to it a single product, single merchant, and single location value that directly correlate, respectively, to a particular product, merchant, and location keyword established by the agency. Consumers have been educated to use the keywords to identify products, merchants, and locations. Thus, a consumer will compose his coupon request using a single keyword to identify a desired product, another keyword to identify a desired merchant, and a third keyword to identify his location. The system then will identify an offer wherein all three keywords match the three values assigned an offer and send a coupon promoting that offer to the consumer.

In practice, however, the set of rules and algorithms for assigning values to merchant offers and consumer requests and using those values to identify responsive coupons may be much more sophisticated. The system may match coupons to requests by additional criteria. For example, a price value may be assigned to offers and consumer then would be able to request coupons based on price ranges. A request for “takeout” or “Chinese” coupons might also specify “budget” or “gourmet” as price value keywords. A single dollar sign ($) might be a keyword for a certain price range, two dollar signs ($$) a keyword for a somewhat higher price range, and three dollar signs ($$$) for an even higher price range. Other criteria may be devised and used.

Moreover, an agency may have a great deal of control over the manner in which it and its merchant clients enter the data into the system. As for coupon requests, however, it must either recognize and exploit the language in common usage by consumers or it must educate them as to the proper language and format for requests. Preferably, it does both, and also allows for the agency and merchants to easily establish keywords in response to changing patterns of usage. The system also as a practical matter should incorporate rules for handling requests that have unrecognizable character strings. For example, such request may be referred to the agency for analysis and possible definition of new keywords and new correlation rules. The system also preferably includes rules for responding to consumer requests if no match is identified, if more than one offer matches the request, or if a series of less than perfect matches are possible.

The system also has been exemplified as matching a consumer's location to a distribution area defined by a merchant. Alternately, however, the system may assign a location value to the coupon request that may be thought of as defining an area where a consumer is willing to redeem coupons. Merchant addresses then might be used as offer location values and to match offers That would allow a consumer to limit, either by default or as an option, the coupons it receives to offers that are honored within, for example, a certain zip code or distance from a specified address.

In any event, once a responsive offer has been identified, the agency computer, in accordance with the subject invention, then sends a coupon promoting an identified offer to the consumer via the electronic mail network, preferably to a consumer's mobile communication device via the mobile communications network. A coupon promoting the identified offer may have been composed and formatted by a merchant and then uploaded into the coupon database. More commonly, however, the agency computer will compose and format a coupon as shown in step 28 of FIG. 2. Much of the coupon content may have been entered as text by a merchant via a client interface webpage. The system also may automatically generate content for a coupon. For example, a branding message on behalf of a merchant or the agency may be included, as may coupon expiration dates. Typically, merchant address and phone numbers will not have been entered as coupon text per se, but will be generated automatically as a result of that information being entered in registering the merchant. In any event, appropriate rules will be applied to the defined content to put the coupon in a format in which it will be distributed. The agency computer 11 then sends the coupon to the consumer's cell phone 16, as shown in step 29.

Generally, it is expected that a single coupon will be sent as the immediate response to a coupon request. Such a service it is believed will have the greatest appeal to consumers. Alternately, however, the system may be programmed to send multiple coupons, including additional coupons that match or do not match the consumer's request. It also may send intermediate or additional messages, for example, to establish a dialogue with a consumer that will provide a more responsive coupon or to ascertain a consumer's interest in additional coupons.

The coupon preferably is sent via the same protocol by which the request is received to ensure that the consumer sending the request is able to receive the coupon. For example, if the coupon request is received as a SMS text message, the coupon is sent to the consumer's mobile telecommunication device as a SMS text message. If the text message request is received from a telecommunication device having more advanced capabilities, such as SMTP text messages from a BlackBerry, the coupon may be sent as a SMTP text message. Many mobile telecommunication devices having more advanced capabilities may also be able to transmit and receive SMS text messages, however, and thus, the coupon could be sent to those devices as such. Thus, the system may enable a particular offer to be formatted for use with different protocols and may allow for different content or additional content depending on the format. For example, coupons sent to devices utilizing SMTP over TCP/IP protocol may easily incorporate a branding logo.

Continuing with the more specific example of how the novel systems and methods may be implemented, consider Bluto Blutarsky, a student at Faber College. The big toga party has reached a fever pitch and the drunken mob filling the Delta Tau Chi house is chanting: “Papa's! Papa's! Papa's!” Bluto pulls out his cell phone and composes the following SMS text message: “faber papa pizza.” Lifting his cell phone high in the air, he presses send. The text message is sent to WHAMtext's computer system, which receives and analyzes the text message. It recognizes “faber” as a keyword location value corresponding to Faber College and also assigns a defined set of zip codes corresponding to the Faber College area as location values. “Papa” is recognized as a merchant keyword value for Papa's, and “pizza” is recognized as the product keyword value for the pizza category. The system then searches its coupon database in an effort to identify coupons for pizza being offered by Papa's in the Faber College marketing area. Because the Faber College area, which was identified in Bluto's text message, and the Rice area, which was assigned by Papa's, share common zip codes, the system identifies Papa's offer for “Two large Meat-Eater pizzas for $20.” It composes a coupon, automatically inserting Papa's address and phone number and an offer code, and sends it back to Bluto's cell phone as a SMS text message.

It will be appreciated that the operation of the agency computer in assigning location values and the like to coupons, in assigning location values and the like to requests, and in identifying responsive coupons based on that information has been described using a certain logic. It is hoped that the logic employed herein will better illustrate and describe the novel systems and methods, and how they may be implemented. They are not limited, however, to that logic. Likewise source code and object code for software used in operating an agency computer system is not limited to the illustrative logic. The content and structure of software used in practicing the invention may be varied in accordance herewith, and various conventional software packages are commercially available or may be readily composed by those skilled in the art.

### Redemption of Coupons

Once a coupon is received by a consumer, it may be handled in various ways depending on the device to which it was delivered. If delivered to an electronic mail device such as a desktop computer that typically has access to a printer, it may be printed and presented to a merchant. If delivered to a mobile telecommunication device in accordance with preferred aspects of the inventions, it is stored and displayed as with any other text message. The consumer is then able to display the coupon to a merchant and receive a discount in accordance with the terms of the offer. Systems also may be devised which will enable the coupon to be presented electronically to the merchant's point of sale system. For example, the coupon may be forwarded to a merchant or a consumer's device and a merchant's point of sale system may be able to communicate through a personal area network.

It will be appreciated that coupons distributed by the novel systems and methods are expected to have much greater effectiveness and to generate relatively higher redemption rates. The novel systems and methods generate coupons on demand in response to specific requests by a consumer. Because they distribute coupons based on a location value assigned to an offer and a consumer's location, and preferably also based on a consumer's product and merchant preferences, they are able to distribute a coupon more closely matching the current interests of a consumer. Even if a perfect match is not distributed, the system is more likely to deliver a coupon that is close enough to the consumer's current interest to influence his purchase decision.

Moreover, because the novel systems and methods utilize coupon requests in the form of text messages that incorporate native language and recognizable keywords, they are simple to use. A consumer is able to receive a coupon by executing a single task, sending a text message or other form of electronic mail. A consumer is not required to register with a service in order to access coupons matching his specific interests. In addition, text message requests and coupons preferably are sent from and to mobile communications devices over a mobile communications network. Cell phones and other mobile communications devices are almost always available to their owners. Thus, the service is much more likely to be available to a consumer, and to distribute a coupon at or very near a purchasing decision. It is expected that such ease of use and accessibility to consumers, coupled with the ability of the system to distribute coupons matching consumer interest on demand and at a point more proximate in time to a purchasing decision will generate significantly higher redemption rates and reduce the amount of advertising that is never viewed, unwelcome, ineffective, or otherwise wasted.

As noted, conventional electronic coupons create an opportunity for fraud. Employees of merchants may falsely claim to have received a coupon from a consumer and then pocket the value of a coupon from the amount paid by a consumer. By not requiring that it be printed, only that it be shown to a merchant, electronic coupons are easier for a consumer to use, but do not create a paper trail. “Phantom” coupons may divert significant revenues from a merchant and do nothing to increase sales.

The subject invention, therefore, provides for novel electronic coupons. More particularly, the novel coupons are stored or displayed on a mobile telecommunication device, preferably as a text message, and comprise a code uniquely identifying the coupon. The “coupon ID” or “CID” preferably consists of a series of text characters which can be recognized by a merchant's employees, for example, a serial number. Preferably the CID will be assigned based on rules that will facilitate the immediate detection of fraudulent coupon codes, such as requiring certain characters to be present at certain locations in the code when defined conditions are satisfied.

It will be understood that the unique coupon code is distinguished from an offer code which also, as noted, may be included in coupons distributed by the novel methods. Offer codes are in common use to identify a particular offer, i.e., a series of identical coupons. If included, a merchant may enter an offer code at the point of sale, for example, so that the proper discount is applied to the transaction and redemption of the coupon is accounted for. The offer code information also may be used by a merchant to track the effectiveness of a campaign or in connection with seeking reimbursement from a manufacturer or franchisor. The offer code, however, will apply to all coupons that, for example, are issued during the course of a particular promotion or that contain similar offers. The same offer code may be included in thousands of coupons, but the CID incorporated in the novel electronic coupons is unique to a particular coupon.

A merchant may require its employees to enter a CID into the merchant's point of sale system to provide an audit trail by which coupons honored by the merchant may be confirmed as having been issued to a consumer. Alternately, the CID may be sent to the merchant, via a text message, e-mail, data transfer, or other appropriate means, preferably at the same time a coupon is sent to a consumer, so that the merchant is able to immediately verify the validity of any codes entered into its point of sale system. The CID may be included in a coupon as a digital signature, hidden text, or embedded code, or as an attachment to the message file which may be transmitted by the consumer's device to a merchant's point of sale system via, for example, a personal area network or by forwarding the coupon to the merchant. The CID also might be a code that is displayed as characters or images, such as a bar code, that may be scanned or otherwise detected by a merchant's point of sale system. Regardless of the form in which it is implemented, however, it is expected that utilizing a unique coupon code will provide an effective deterrent to dishonest employees who otherwise might try to profit from “phantom” coupons.

The subject invention also provides for novel electronic coupons transmitted to a mobile telecommunication device with a digital signature certifying the authenticity of the coupon. The coupons may be forwarded to a merchant so that it is able to verify the signature, or the consumer's device and merchant's point of sale system may communicate via a personal area network. There are many systems for attaching and verifying digital signatures, and they generally may be adapted for use with the novel coupons.

It will be appreciated, however, that a CID consisting of a series of text characters displayed in a text message provides a simple, yet effective way for creating a paper trail in the context of even the most basic point of sale systems. A merchant may simply prepare a handwritten list which then may be compared to reports available on the agency system. More sophisticated point of sale systems may allow for entry of a CID. A merchant, however, is not required to invest in a new point of sale system.

Moreover, a CID is useful not only for purposes of deterring fraud, but it may be used to track individual coupons. For example, it may enable agencies and merchants to determine whether and to what extent particular offers are forwarded or otherwise redistributed by the original recipient. Such information may be useful for more accurately measuring the value of a campaign.

Continuing again with the more specific example of how the novel systems and methods may be implemented, Bluto now has received a text message from WHAMtext. He opens the message, finds the “Two large Meat-Eater pizzas for $20” coupon from Papa's, and announces that he has a mission for his favorite pledges, Pinto and Flounder. They must go to Papa's. Eager to please, they grab his cell phone and head for Papa's. When they arrive, they display the text message to the cashier. The cashier enters the offer code into Papa's point of sale system, and it makes the appropriate price adjustments. WHAMtext also has included a CID in the coupon. The cashier enters the CID in the point of sale system. Papa then will be able to compare that CID to the information posted by WHAMtext on its client interface page. Pinto and Flounder return to the frat house, hot steaming pies in hand, as conquering heroes.

### Tracking Coupons

In accordance with other preferred aspects of the invention, the agency computer preferably makes a record of each request and each delivery as shown in step 30 of FIG. 2 and analyzes that data to facilitate billing for the service and providing additional enhancements to the service. For example, the agency computer 11 preferably makes a record in the database 12 of coupons distributed for each merchant. That record may be used to generate billing data and issue billing statements as shown in step 31. Thus, unlike conventional coupon delivery services, the novel methods can virtually assure that the merchant will pay only for coupons that are actually viewed by consumers. Thus, even if the coupon is not redeemed, the merchant still receives the benefit of having distributed a branding message.

By making a record of consumer requests, it also will be appreciated that the subject invention is able to provide methods for distributing coupons that more closely match a consumer's interest and that are not generated in response to an immediate request. That is, the agency computer may be operated to make a record of a plurality of requests received from a consumer, to analyze those requests to identify products or merchants of interest to the consumer, and then send the consumer, preferably via his mobile communication device and a mobile communications network, coupons for products or from merchants identified by the analysis.

For example, as shown in step 32 the agency computer 11 analyzes coupon delivery records for a consumer, who typically will be identified only by his phone number, to identify what merchants and products may be of interest to the consumer. The merchants and products of potential interest may be those merchants and products for which coupons have been requested of course. They also may be different merchants and products for which the pattern of requests suggests there may be cross demand. In any event, as shown in step 33, the agency computer 11 then may be used to send additional coupons to the consumer that are directed to identified merchants and products which are believed to match his interest. The history of requests also may be analyzed to identify patterns in the day and time of requests. That information also may be used to distribute coupons at a time when the consumer is expected to be most receptive to such offers. In practice such a service may be operated as an “opt-in” service by allowing the consumer to register with the agency, or it may be operated as an “opt-out” service where delivery of unrequested coupons is suspended.

It also will be appreciated that a record of prior coupon requests may be analyzed and used, along with current information provided therein, to deliver a coupon in response to a specific coupon request. The system thereby may be able to deliver coupons more closely matching the consumer's interests, even if those interests are not expressed in the current request. For example, if no location information is specified in a current request, the system may deliver a coupon to a consumer based on location information that he has included in his prior requests.

The systems and methods of the novel invention involve the use of computers, preferably digital computers, and other conventional data processing equipment. Such computer systems, as appreciated by workers in the art, typically will comprise a storage device and a processor connected to the storage device, wherein the storage device stores a software program for controlling the processor and its operations on information stored in a database. Appropriate routers, modems, gateways, and other interfaces are provided to interconnect the system and to connect the system to electronic mail networks and preferably to mobile telecommunications networks. Such hardware is conventional and may be obtained commercially from numerous sources, and it may be configured and assembled by those skilled in the art in various ways to practice the subject invention. Likewise, the system may be controlled by software that is commercially available or that may be easily written in accordance with the disclosure herein. Such software also may be. designed to distribute coupons by methods, or to accomplish other purposes that are outside the scope of, but complimentary to the novel systems and methods. Accordingly, it will be appreciated that suitable software will include a multitude of discrete commands and operations that may combine or overlap with the steps as described herein. Thus, the precise structure or logic of the software at both at the source and object code level may be varied considerably while still practicing the invention.

While this invention has been disclosed and discussed primarily in terms of specific embodiments thereof, it is not intended to be limited thereto. Other modifications and embodiments will be apparent to the worker in the art.

A system for distributing on demand coupons that may be redeemed by consumers, the system comprising: (a) an agency computer having access to a coupon database comprising information defining one or more offers and a location value assigned to each offer; (b) the agency computer being connectable to a network for transmitting electronic mail; (c) the agency computer operable to receive requests for coupons from consumers via the electronic mail network; (d) the consumer coupon requests being a text message including information identifying the consumer's location; (e) the agency computer being operable to identify an offer in the database that is responsive to the consumer coupon request based on the consumer location information and the offer location value and to send a coupon for the identified offer to the consumer via the network for transmitting electronic mail.

The systems as described above, wherein the agency computer is connectable to mobile telecommunication devices via a mobile communications network, is operable to receive requests originating from mobile telecommunication devices and being transmitted to the agency computer via the mobile communications network, and is operable to send the coupon to the consumer mobile communication device via the mobile communications network.

The systems as described above, wherein the system comprises a mobile communications network connection and the coupon is sent via the network connection.

The systems as described above, wherein the system is operable to receive coupon requests from consumers who are not registered on the system.

The systems as described above, wherein the location information is embedded in the coupon request.

The systems as described above, wherein the agency computer is operable to make a record of coupons requested by a consumer.

The systems as described above, wherein the agency computer is operable to make a record of coupons distributed for a merchant.

The systems as described above, wherein the agency computer is operable to generate billing data for the merchant based on the record of coupons distributed for the merchant.

The systems as described above, wherein the offer location value is selected from the group consisting of street addresses, zip codes, geographic regions, political divisions, institutions, and landmarks.

The systems as described above, wherein the consumer location information included in the coupon request is selected from the group consisting of street addresses, zip codes, geographic regions, political divisions, institutions, and landmarks.

The systems as described above, wherein the coupon database comprises a product value assigned to each offer and the coupon request includes information identifying a desired product and the agency computer identifies an offer in the database responsive to the coupon request based on the desired product information and the offer product value.

The systems as described above, wherein the coupon database comprises a merchant value assigned to each offer and the coupon request includes information identifying a desired merchant and the agency computer identifies an offer in the database responsive to the coupon request based on the desired merchant information and the offer merchant value.

The systems as described above, wherein the consumer location information is a keyword recognized by the system as having a location value and the offer is identified based on the keyword location value and the offer location value.

The systems as described above, wherein a least a portion of the merchant information is inputted into the agency computer system by merchants accessing the agency computer system via an agency website.

The systems as described above, wherein the coupon request is a short message service text message.

The systems as described above, wherein the coupon is a text message.

The systems as described above, wherein the coupon is a short message service text message.

The systems as described above, wherein the coupon includes a text code uniquely identifying the coupon.

A system for distributing coupons of interest to consumers, the system comprising the systems as described above, wherein the wherein the agency computer is operable: (a) to make a record of coupons requested by the consumer; (b) to analyze the coupon request record to identify products or merchants of interest to the consumer; and (c) to send to the consumer via the network for transmitting electronic mail a coupon for offers for products or from merchants identified by the analysis.

A coupon distributed by the systems as described above, and such coupons wherein the coupon comprises a code uniquely identifying the coupon, wherein the coupon and the coupon code are displayed as a text message, or wherein the coupon comprises a code uniquely identifying the coupon and the coupon and the coupon code are displayed as a short message system text message.

A method of distributing on demand coupons that may be redeemed by consumers, the method comprising: (a) providing a merchant database accessible to an agency computer system, the merchant database comprising information defining one or more offers and a location value assigned to each offer; (b) operating the agency computer system to receive a request for coupons from a consumer, the request being transmitted to the computer system via a network for transmitting electronic mail and being a text message including information identifying the consumer's location; (c) operating the agency computer system to identify an offer in the database that is responsive to the consumer coupon request based on the consumer location information and the offer location value; and (d) sending a coupon for the identified offer to the consumer via the network for transmitting electronic mail.

1. A coupon stored or displayed on a mobile telecommunication device, said coupon comprising a code uniquely identifying said coupon.

2. The coupon of claim 1, wherein said coupon and said coupon code are displayed as a text message.

3. The coupon of claim 1, wherein said coupon and said coupon code are displayed as a short message system text message.

4. A coupon stored or displayed on a mobile telecommunication device, said coupon having a digital signature.

5. The coupon of claim 4, wherein said digital signature uniquely identifies said coupon.

6. A system for distributing on demand coupons that may be redeemed by consumers, said system comprising:
(a) an agency computer having access to a coupon database comprising information defining one or more offers and a location value assigned to each said offer;
(b) said agency computer being connectable to a network for transmitting electronic mail;
(c) said agency computer operable to receive requests for coupons from consumers via said electronic mail network;
(d) said consumer coupon requests being a text message including information identifying said consumer's location;
(e) said agency computer being operable to identify an offer in said database that is responsive to said consumer coupon request based on said consumer location information and said offer location value and to send a coupon for said identified offer to said consumer via said network for transmitting electronic mail.

7. The system of claim 6, wherein said agency computer is connectable to mobile telecommunication devices via a mobile communications network, is operable to receive requests originating from mobile telecommunication devices and being transmitted to said agency computer via said mobile communications network, and is operable to send said coupon to said consumer mobile communication device via said mobile communications network.

8. The system of claim 7, wherein said system comprises a mobile communications network connection and said coupon is sent via said network connection.

9. The system of claim 6, wherein said system is operable to receive coupon requests from consumers who are not registered on said system.

10. The system of claim 6, wherein said agency computer is operable to make a record of coupons requested by a consumer.

11. The system of claim 6, wherein said agency computer is operable to make a record of coupons distributed for a merchant.

12. The system of claim 11, wherein said agency computer is operable to generate billing data for said merchant based on the record of coupons distributed for said merchant.

13. The system of claim 6, wherein said offer location value is selected from the group consisting of street addresses, zip codes, geographic regions, political divisions, institutions, and landmarks.

14. The system of claim 6, wherein said consumer location information included in said coupon request is selected from the group consisting of street addresses, zip codes, geographic regions, political divisions, institutions, and landmarks.

15. The system of claim 6, wherein said coupon database comprises a product value assigned to each said offer and said coupon request includes information identifying a desired product and said agency computer identifies an offer in said database responsive to said coupon request based on said desired product information and said offer product value.

16. The system of claim 6, wherein said coupon database comprises a merchant value assigned to each said offer and said coupon request includes information identifying a desired merchant and said agency computer identifies an offer in said database responsive to said coupon request based on said desired merchant information and said offer merchant value.

17. The system of claim 6, wherein said consumer location information is a keyword recognized by the system as having a location value and said offer is identified based on said keyword location value and said offer location value.

18. The system of claim 6, wherein a least a portion of said merchant information is inputted into said agency computer system by merchants accessing said agency computer system via an agency website.

19. The system of claim 6, wherein said coupon request is a short message service text message.

20. The system of claim 6, wherein said coupon is a text message.

21. The system of claim 7, wherein said coupon is a short message service text message.

22. The system of claim 6, wherein said coupon includes a code uniquely identifying said coupon.

23. The system of claim 6, wherein said coupon includes a digital signature uniquely identifying said coupon.

24. A system for distributing coupons of interest to consumers, said system comprising the system of claim 6, wherein said wherein said agency computer is operable:
(a) to make a record of coupons requested by said consumer;
(b) to analyze said coupon request record to identify products or merchants of interest to said consumer; and
(c) to send to said consumer via said network for transmitting electronic mail a coupon for offers for products or from merchants identified by said analysis.

25. A coupon distributed by the system of claim 6.

26. The coupon of claim 25, wherein said coupon comprises a code uniquely identifying said coupon.

27. The coupon of claim 26, wherein said coupon is displayed as a text message and said code uniquely identifying said coupon is a digital signature.

28. A method of distributing on demand coupons that may be redeemed by consumers, said method comprising:
(a) providing a merchant database accessible to an agency computer system, said merchant database comprising information defining one or more offers and a location value assigned to each said offer;
(b) operating said agency computer system to receive a request for coupons from a consumer, said request being transmitted to said computer system via a network for transmitting electronic mail and being a text message including information identifying said consumer's location;
(c) operating said agency computer system to identify an offer in said database that is responsive to said consumer coupon request based on said consumer location information and said offer location value;
(d) sending a coupon for said identified offer to said consumer via said network for transmitting electronic mail.
